(19) United States
(12) Patent Application Publication
(10) Pub. No.: US 2007/0127544 A1
(43) Pub. Date: Jun. 7, 2007

(54) THERMAL SHOCK TESTER

(75) Inventor: CHUAN-DE HUANG, Tu-Cheng,Taipei Hsien (TW)

Correspondence Address: PCE INDUSTRY, INC.;ATT. CHENG-JU CHIANG JEFFREY T. KNAPP, 458 E. LAMBERT ROAD, FULLERTON, CA, 92835, US

(73) Assignee: HON HAI PRECISION INDUSTRY CO., LTD., Taipei Hsien (TW)

(21) Appl. No.: 11/309,747

(22) Filed: Sep. 21, 2006

(30) Foreign Application Priority Data
Dec. 2, 2005 (CN) 200510102029.1

(51) Int. Cl. G01N 17/00

(52) U.S. Cl. 374/57

(57) ABSTRACT

An exemplary thermal shock tester including a main body (11) and a temperature adjuster, the main body including a lid (112) and defining a test area (114); the temperature adjuster including a heater (15) and a cooler, wherein the heater and the cooler is respectively configured for increasing and decreasing the temperature in the test area. An exemplary thermal shock testing method is also disclosed.

### FIELD OF THE INVENTION

The present invention generally relates to thermal shock testers, and more particularly to a relatively cheap and simple thermal shock tester.

### DESCRIPTION OF RELATED ART

With the development of technology, electronic products are more and more important in our everyday lives. In manufacturing, performance testing of finished or half-finished products is quite important. To ensure that the products function properly in differing temperature conditions, thermal resistance test of the product is necessary.

However, a general thermal testing instrument is relatively complex and expensive. In addition, some thermal testing instruments may need to be modified for individual test subjects. Furthermore, current thermal testing instruments are not fit for use in the lab while developing a new product. As a result, research and development are made more expensive.

Accordingly, what is needed is a relatively inexpensive thermal shock tester with relatively simple structure.

### SUMMARY OF THE INVENTION

In one embodiment thereof, a thermal shock tester includes a main body and a temperature adjuster. The main body includes a lid and defines a test area. The temperature adjuster includes a heater. The heater is provided with the main body for increasing the temperature in the test area.

A thermal shock testing method including the following steps: providing thermal shock tester including a main body having a lid and defining a test area, a temperature adjuster having a heater and a cooler configured for use with the main body, and a temperature sensor; providing some purificant and some refrigerant. Providing a sample to be tested; the sample to be tested is put in the test area, and test area is sealed with the lid; when doing a heat-resistance test, all the valves are closed, the heater is activated, the temperature in the test area is increased by thermal input from the heater, the needed temperature in the test area can be controlled with the assistance of the temperature sensor; during a cooling test, the air condition in test area is refreshed by the purificant input through the cooler, moderate refrigerant is input through the cooler, and the temperature in the test area is decreased, the needed temperature in the test area can be controlled using the temperature sensor; and the sample to be tested is removed from the test area.

Other advantages and novel features will become more apparent from the following detailed description when taken in conjunction with the accompanying drawings.

### BRIEF DESCRIPTION OF THE DRAWINGS

Many aspects of the thermal shock tester can be better understood with reference to the following drawings. The components in the drawings are not necessarily drawn to scale, the emphasis instead being placed upon clearly illustrating the principles of the present thermal shock tester. Moreover, in the drawings, like reference numerals designate corresponding parts throughout the several views.

FIG. 1 is an isometric view of a thermal shock tester in accordance with an preferred embodiment of the present invention; and

FIG. 2 is a partly cut-away view of the thermal shock tester shown in FIG. 1.

### DETAILED DESCRIPTION OF THE INVENTION

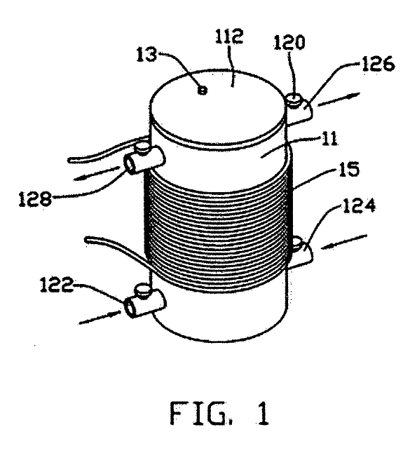

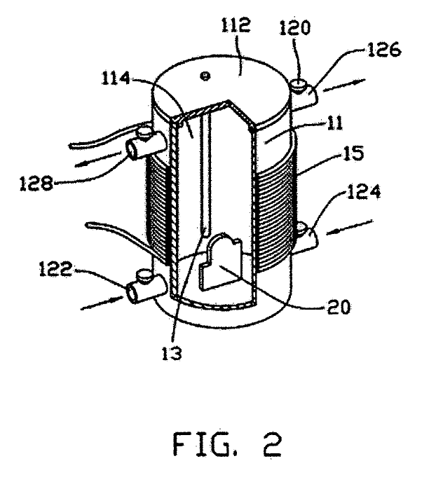

Referring to FIG. 1 and FIG. 2, a thermal shock tester 10 of an preferred embodiment includes a main body 11, a temperature adjuster, and a temperature sensor 13.

The main body 11 is a hollow cylinder having a lid 112 in one end thereof. The lid 112 is a thin board. The main body 11 defines a cavity that is a test area 114. The test area 114 is a close space sealed by the lid 112. When the lid 112 is uncapped, a sample to be tested 20 is put in or removed from the test area 114. The size and shape of the main body 11 can also be designed according to the size and shape of the sample to be tested 20.

The temperature adjuster includes a cooler (not labeled) and a heater 15. The cooler includes pipes 122, 124, 126 and 128, and plural valves 120. The pipes 122, 124, 126 and 128 are formed through the periphery of the main body 11 and near the two ends of the main body 11. One end of each of the pipes 122, 124, 126 and 128 is connected to the test area 114, and the other end is connected to the outside of the main body 11. Each of the pipes 122, 124, 126, and 128 has a valve 120 for controlling flow of cooling media, such as cooling gas or liquid in and out the test area 114. In the present embodiment, the valve 120 is a manual-controlled valve. Alternatively, the valve 120 can also be provided as an auto valve, such as a magnetic valve. The cooler is configured for decreasing the temperature in the test area 114 by using moderate refrigerant such as liquefied inert gases like liquid nitrogen (N2), liquid argon (Ar), and liquid carbon dioxide (CO2). The cooler is also used to purge the air using a certain purificant such as inert gas N2, Ar and CO2, and the like.

The heater 15 can be chosen from the group consisting of resistance heaters, electron-beam heaters, arc heaters, radium heaters or the like. In the embodiment, the heater 15 is a heating circuit. The heater 15 is fitted around the periphery of the main body 11. Through thermal conduction, the temperature in the test area 14 can be increased. Alternatively, the heater 15 can also be attached in the inner of the main body 11 to increase the temperature in the test area 114.

The temperature sensor 13 is provided for testing temperature in the test area 114 of the main body 11. The temperature sensor 13 is inserted into the test area 114 through the lid 112. One end of the temperature sensor 13 is provided for temperature sensing and retained in the test area 114. The other end of the temperature sensor 13 is provided for displaying the temperature, and it protrudes a little from the lid 112 to be convenient for reading the related data shown by the temperature sensor 13. The temperature sensor 13 can be chosen from the group consisting of thermometers, a thermographs and temperature probes. The temperature sensor 13 can also be used with a PID (proportional integral derivative) controlling module (not shown). The PID controlling module is electrically connected with the temperature sensor 13. The PID controlling module can control the valve 120 to open or close based on the temperature information sensed by the temperature sensor 13.

During test, some purificant and some refrigerant is provided. The sample to be tested 20 is put in the test area 14. The temperature sensor 13 is assembled with the main body 11. The test area 114 is sealed with the lid 112.

In a cooling test, the liquid input and the liquid output are closed, that is, the valve 120 on each of the pipes 122 and 126 are closed. Some purificant is input into the test area 114 through the pipe 124, and the air formerly retained in the test area 114 is output from the test area 114 through the pipe 128, so that the air condition in test area 114 is refreshed. The valve 120 configured on each of the pipes 124, 126 and 128 is closed, and the valve 120 configured on the pipe 122 is opened to make the refrigerant input through the pipe 122, so that the temperature in the test area 114 is decreased. Based on the temperature sensed by the temperature sensor 13, the temperature in the test area 114 can be controlled according to need by adjusting the valve 120 configured on the pipe 122.

In a heat-resistance test, each valve 120 is closed. The heater 15 is activated. The temperature in the test area 114 is increased by thermal input from the heater 15. The needed temperature in the test area 114 can be controlled based on the temperature sensed by the temperature sensor 13.

In addition, the temperature sensor 13 can be wholly retained in the test area 114, and the main body 11 can be made transparent allow of the temperature sensor 13. The temperature sensor 13 can be omitted, and the temperature in the test area 114 can be controlled according to the thermoregulation modulus of the refrigerant, that is, the relationship between the refrigerant and the difference in temperature, so that controlling the temperature in the test area 114 can be implemented by controlling a flow velocity and duration of the refrigerant. It is to be understood that the purificant can be omitted, and only the heating or cooling process is carried out. The pipes 122, 124, 126 and 128 and the plural valves 120 can be omitted, in cooling test, the refrigerant can be input into the test area 114 with the lid 112 uncapped.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

1. A thermal shock tester comprising:
a main body including a lid and defining a test area configured for receiving one or more work pieces;
a temperature adjuster including a heater and a cooler, wherein the heater and the cooler are respectively configured for increasing and decreasing the temperature in the test area.

2. The thermal shock tester as claimed in claim 1, wherein the test area is a closed space sealed with the lid, the lid being removable so as to allow enter and removal of a sample to be tested.

3. The thermal shock tester as claimed in claim 2, wherein the size and shape of the main body are configured according to the sample to be tested.

4. The thermal shock tester as claimed in claim 1, wherein the main body is a hollow cylinder with the lid in one end thereof.

5. The thermal shock tester as claimed in claim 1, wherein the heater is fitted around the periphery of the main body.

6. The thermal shock tester as claimed in claim 1, wherein the heater is attached inside the main body.

7. The thermal shock tester as claimed in claim 1, wherein the cooler has a plurality of pipes with valves, the valves engage with their respective pipes.

8. The thermal shock tester as claimed in claim 7, wherein the pipes are formed through the periphery of the main body.

9. (canceled)

10. The thermal shock tester as claimed in claim 9, wherein one end of the temperature sensor is retained in the test area for temperature sensing, the other end of the temperature sensor is provided for displaying the temperature.

11. The thermal shock tester as claimed in claim 9, wherein the temperature sensor is used with a PID (proportional integral derivative) controlling module electrically connected therewith, and PID controlling module is configured for controlling the valve to open or close based on the temperature information sensed by the temperature sensor.

12. The thermal shock tester as claimed in claim 7, wherein the cooler is configured for decreasing the temperature in the test area using refrigerant.

13. The thermal shock tester as claimed in claim 12, wherein the refrigerant is liquefied inert gas chosen from the group consisting of liquid nitrogen (N2), liquid argon (Ar) and liquid carbon dioxide (CO2).

14. The thermal shock tester as claimed in claim 7, wherein the cooler is used for purging the air using a purificant chosen from the group consisting of N2, Ar and CO2.

15. A thermal shock testing method comprising:
providing a thermal shock tester including a main body having a lid and defining a test area, a temperature adjuster having a heater and a cooler configured with the main body, and a temperature sensor;
providing some purificant and some refrigerant;
receiving one or more samples to be tested in the testing area;
sealing the test area with the lid;
wherein if in a heat-resistance test, all the valves are closed, the heater is activated, the temperature in the test area is increased by thermal conduction with the heater, the needed temperature in the test area is controlled with the assistance of the temperature sensor;
wherein if in a cooling test, the air condition in test area is refreshed by the purificant input through the cooler, moderate refrigerant is input through the cooler, and the temperature in the test area is decreased, the needed temperature in the test area is controlled with reference to the temperature sensor; and
taking the tested samples out of the test area after the heat-resistance test or cooling test is completed.

16. The thermal shock testing method as claimed in claim 15, wherein the cooler includes plural pipes and valves, the pipes are respectively configured for use for liquid input, airflow input, liquid output and airflow output, and the valves are configured for controlling the pipes to be open or closed.

17. The thermal shock tester as claimed in claim 1, wherein the thermal shock tester further includes a temperature sensor for testing temperature in the test area.

18. The thermal shock tester as claimed in claim 7, wherein the thermal shock tester further includes a temperature sensor for testing temperature in the test area.
